(19) United States
(12) Patent Application Publication
(10) Pub. No.: US 2026/0041052 A1
(43) Pub. Date: Feb. 12, 2026

(54) SYSTEM FOR WATERING PLANTS

(71) Applicant: SUPA SOLUTION (PTY) LTD, Stellenbosch (ZA)

(72) Inventors: Malem Scheepers HEYMANS, Potchefstroom (ZA); Heinz Otto REINSTORF, George (ZA)

(73) Assignee: SUPA SOLUTION (PTY) LTD, Stellenbosch (ZA)

(21) Appl. No.: 18/995,481

(22) PCT Filed: Jul. 19, 2023
(86) PCT No.: PCT/ZA2023/050038

§ 371 Date: Jan. 16, 2025

(30) Foreign Application Priority Data
Aug. 2, 2022 (ZA) 2022/08610

(51) Int. Cl. A01G 27/00

(52) U.S. Cl. CPC A01G 27/003; A01G 27/001; A01G 27/008

(57) ABSTRACT

A plant watering system (10) includes: a plurality of containers (12) for containing plant growing medium and plants (20); a conduit (16) defining an outlet ((18) for, in use, conveying water along the conduit and discharging water via the conduit outlet; a regulator (22) for regulating the flow of water along the conduit; a scale (14) associated with one of the containers for determining the weight of the associated container; a controller (24) that controls the regulator, thereby to vary the flow of water along the conduit in response to the container weight determined by the scale; and means for moving the conduit outlet across the plurality of containers, in use to provide water to the plurality of containers.

### BACKGROUND

The present invention relates to a system for watering plants. More specifically, the present invention relates to a system that provides water to plants based on the weight of the containers in which the plants are grown.

Various systems that monitor the weight of potted plants are known. For instance, US2002/0024445 “Flower container with water sensor and message reproducing device” and U.S. Pat. No. 6,295,865 “Moisture level indicator” describe a potted plant, a scale for monitoring the weight of the potted plant and a speaker/display for signalling an alert that the potted plant is under/over watered.

Furthermore, various watering systems that use scales to turn the water on and off are also known. For instance:
US2015/0289460 “Automated plant irrigation method and system using weight and leak sensors”, U.S. Pat. No. 2,198,309 “Automatic receptacle filling apparatus”, U.S. Pat. No. 2,828,935 “Automatic container filler”, U.S. Pat. No. 3,293,799 “Automatic irrigation of pot cultures in plant growth rooms and greenhouses” and U.S. Pat. No. 4,760,666 “Watering device for plants” describe: a potted plant/container; a conduit for providing water to the potted plant/container; a valve that switches the flow of water along the conduit between an “on” position (in which water is permitted to flow along the conduit) and an “off” position (in which water is not permitted to flow along the conduit); and a scale associated with the potted plant/container, which scale is associated with the valve to switch the valve between the on and off positions depending on the weight of the potted plant/container;
U.S. Pat. No. 8,584,397 “Automated plant watering system” describes a series of potted plants; a conduit that branches to provide water to each of the potted plants; a valve associated with each branch, which valve switches the flow of water along the associated valve between an “on” position (in which water is permitted to flow along the associated branch) and an “off” position (in which water is not permitted to flow along the associated branch); and a scale associated with each potted plant, which scale switches the valve that controls water flow along the branch to the associated potted plant between the on and off positions depending on the weight of the associated potted plant; and
U.S. Pat. No. 6,161,329 “Automatic watering device for potted plants” describes: a series of potted plants; a primary conduit that branches to discharge water to each of the potted plants; a valve that switches the flow of water along the primary conduit between an “on” position (in which water is permitted to flow along the primary conduit) and an “off” position (in which water is not permitted to flow along the primary conduit); and a scale associated with one of the potted plants, which scale is associated with the valve to switch the valve between the on and off positions depending on the weight of the potted plant.

A drawback of the systems described in US2015/0289460, U.S. Pat. Nos. 2,198,309, 2,828,935, 3,293,799, 4,760,666 and 8,584,397 is that a scale is required in respect of each potted plant, whereas, a drawback of the system described in U.S. Pat. No. 6,161,329 is that a conduit branch must extend to each potted plant.

A further drawback of the systems described in US2015/0289460, U.S. Pat. Nos. 2,198,309, 2,828,935, 3,293,799, 4,760,666, 8,584,397 and 6,161,329 is that the scale merely switches the valve between the on and off positions. The scale does not regulate flow of water through the conduits and branches between minimum and maximum flow.

It is an object of the present invention to address the above drawbacks and to provide a plant watering system wherein:
a single scale can control the flow of water to a plurality of containers (with plants);
a single conduit is movable over/across a plurality of containers (with plants) to provide water to such containers/plants; and
the weight of the container monitored by the scale determines the:
   flow of water through the conduit between: an “on” position (in which water is permitted to flow along the conduit), an “off” position (in which water is not permitted to flow along the primary conduit), and at least one intermediate position between the on and off positions; and
   the speed at which the conduit moves over/across the plurality of containers (with plants).

### SUMMARY OF THE INVENTION

According to a preferred embodiment of the invention, there is provided a plant watering system that includes:
a plurality of containers for containing plant growing medium and plants;
a conduit defining an outlet for, in use, conveying water along the conduit and discharging water via the conduit outlet;
a regulator for regulating the flow of water along the conduit;
a scale associated with one of the containers for determining the weight of the associated container;
a controller that controls the regulator, thereby to vary the flow of water along the conduit in response to the container weight determined by the scale; and
means for moving the conduit outlet across the plurality of containers, in use to provide water to the plurality of containers.

Typically, the plant watering system further includes a database that stores:
a first predetermined weight associated with zero flow along the conduit;
a second predetermined weight associated with 100% flow along the conduit; and
at least one intermediate weight associated with flow along the conduit that is between 0% and maximum flow along the conduit.

Generally, the controller includes a processor that controls the regulator in response to: the weight determined by the scale; and the data in the database.

Preferably, the conduit moving means comprises either:
a hinged mount on which the conduit is mounted; and an actuator or motor for angularly displacing the conduit about the hinged mount; or
a runner on which the conduit is mounted; a rail along which the runner is movable; and an actuator or motor for moving the runner along the rail.

Typically, the database further includes:
a zero actuator or motor speed associated with the first predetermined weight;
a first actuator or motor speed associated with the second predetermined weight; and
a second actuator or motor speed associated with at least one intermediate weight.

Generally, the speed of the actuator or motor is also controlled by the controller in response to: the weight determined by the scale; and the data in the database.

Preferably, the scale is substantially dome-shaped, in use, to facilitate water runoff from the scale.

Typically, the regulator is a valve or a pump controller.

### BRIEF DESCRIPTION OF THE DRAWINGS

The invention will now be described in more detail, by way of example only, with reference to the accompanying drawings in which:

FIG. 1 is a schematic drawing of the plant watering system according to a preferred embodiment of the invention;

FIG. 2 is a perspective view of a scale that forms part of the plant watering system in FIG. 1; and

FIG. 3 is a graph detailing an example of data obtained from use of the watering system in FIG. 1.

### DESCRIPTION OF THE INVENTION

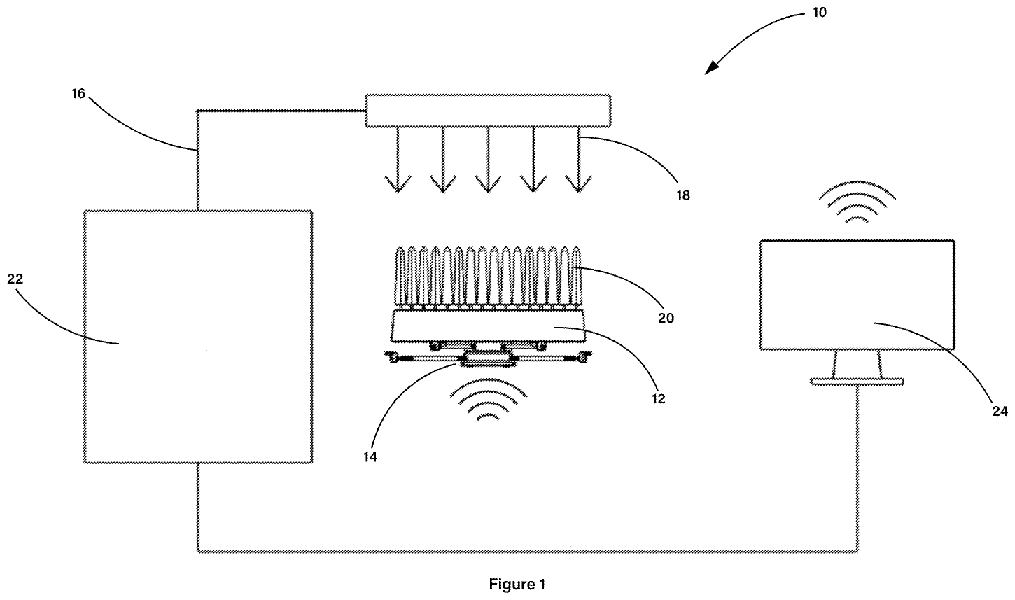

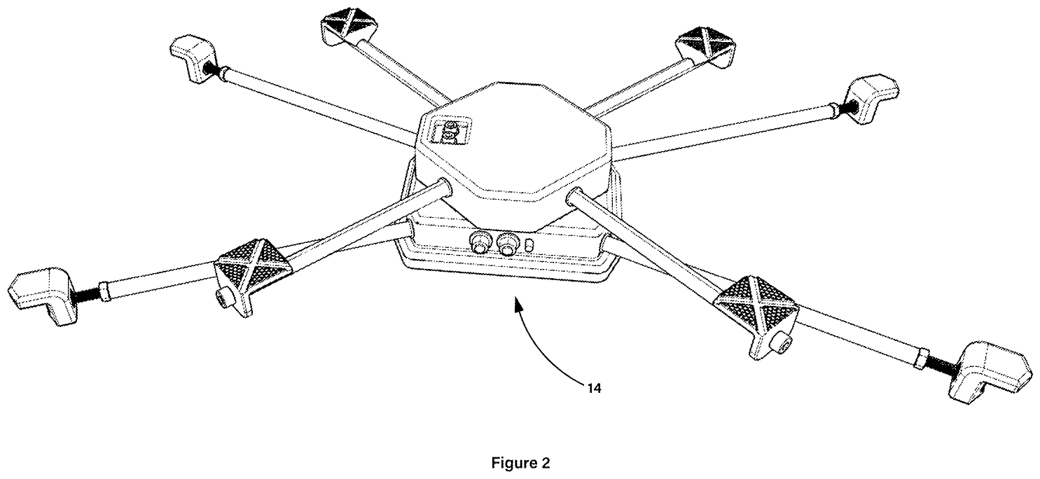

With reference to FIGS. 1 and 2, a plant watering system 10 according to a preferred embodiment of the invention includes: a plurality of containers 12; a scale 14; a conduit 16 that defines an outlet 18; and means (not shown) for moving the conduit 16 outlet 18 across/over the plurality of containers 12.

Each container 12 is in the form of a tray that defines a series of receptacles for receiving plant growing medium (e.g. soil) and plant seedlings 20 therein.

The scale 14 shown in FIG. 2 is sized to locate under a container 12. The scale 14 is substantially dome-shaped to facilitate water runoff from the operative upper surface of the scale 14. However, the operative upper surface of the scale 14 defines formations to support the container 12 thereon. Importantly, the plant watering system 10 includes fewer scales 14 than containers 12. Preferably, the plant watering system 10 includes a plurality of containers 12 and only one scale 14. In use, the scale 14 determines/monitors the weight of the container 12 (with plant growing medium and plants/seedlings 20 contained therein) supported thereon.

The conduit 16 is in the form of a tube that defines at least one outlet 18, which conduit 16 outlet 18 is movable over/across the plurality of containers 12. In use, the conduit 16 conveys water there along and, by passing over the containers 12, the conduit 16 outlet 18 provides water to the plurality of containers. Typically, a sprayer is associated with the conduit 16 outlet 18 to diffuse water exiting the conduit 16 outlet 18.

The means for moving the conduit 16 outlet 18 across the plurality of containers 12 comprises a hinged mount (not shown) on which the conduit 16 is mounted; and an actuator or motor (not shown) for angularly displacing the conduit 16 about the hinged mount.

According to an alternative embodiment (not shown) of the means for moving the conduit 16 outlet 18 across the plurality of containers 12, the means could comprise: a runner on which the conduit is mounted; a rail along which the runner is movable; and an actuator or motor for moving the runner along the rail.

By moving the conduit 16 outlet 18 across/over the plurality of containers 12, a single conduit 18 may be used to provide water to all the containers 12. This should be contrasted with the watering systems described in the prior art patents, wherein a separate conduit or conduit branch is required to provide water to each of the containers, or, put another way, wherein a conduit outlet is associated with each container.

Turning back to the preferred embodiment of the plant watering system 10 shown in FIG. 1, a regulator 22 is in the form of either: a valve associated with the conduit 16; or a pump controller associated with a pump that provides pressurised water to the conduit 16. The regulator 22 regulates the flow of water along the conduit 16 between:
a zero flow rate along the conduit 16;
a 100% flow rate along the conduit 16; and
at least one intermediate flow rate along the conduit 16, which intermediate flow rate is greater than the zero flow rate and less than the 100% flow rate along the conduit 16.

A controller 24 controls the regulator 22, thereby to control/vary the flow of water along the conduit 16 in response to the container 12 weight determined by the scale 14.

The controller 24 includes a processor (not shown) and a database (not shown) that stores/includes the following data:
a first predetermined weight of the monitored container 12 associated with zero flow along the conduit 16;
a second predetermined weight of the monitored container 12 associated with 100% flow along the conduit 16;
at least one intermediate weight of the monitored container 12 associated with flow along the conduit 16 that is between minimum (0%) and maximum (100%) flow along the conduit 16;
a zero actuator or motor speed associated with the first predetermined weight of the monitored container 12;
a first actuator or motor speed associated with the second predetermined weight of the container 12; and
a second actuator or motor speed associated with at least one intermediate weight of the container 12.

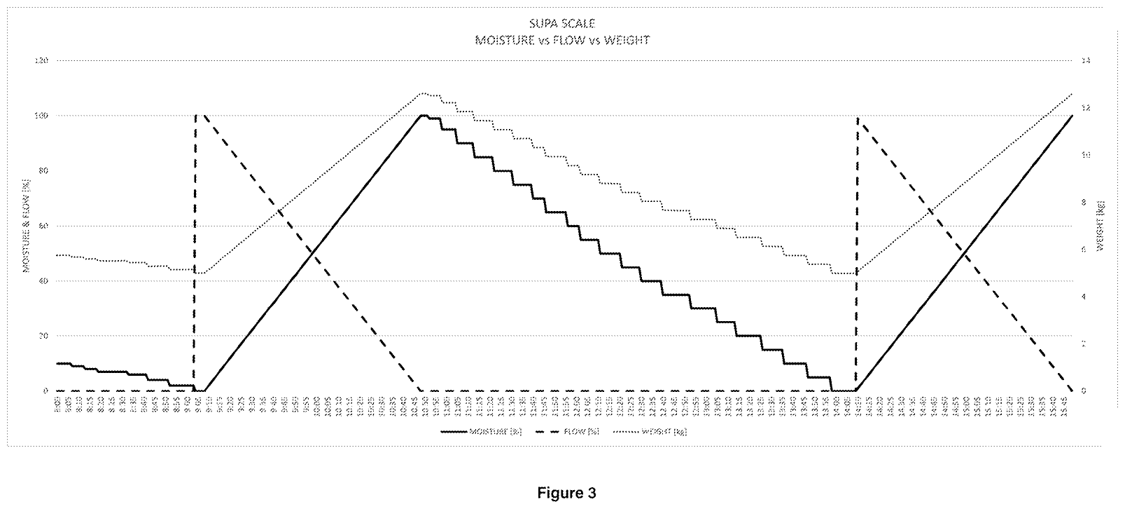

FIG. 3 is a graph detailing an example of database data and data generated by the watering system 10 in use. The graph shows the weight of the monitored container 12, flow %/rate along conduit 16 and moisture %. In addition, the database could include a column for actuator/motor speed, for example:

| Weight of the | | |
|---|---|---|
| monitored | Flow rate along the conduit 16 | Actuator/motor speed |
| container 12 | (litres/minute) | (metres/second) |
| 200 g+ | 0 | 0 |
| 180 g-199 g | 5 | 0.1 |
| 160 g-179 g | 6 | 0.13 |
| 140 g-159 g | 7 | 0.15 |
| 120 g-139 g | 8 | 0.15 |

The processor:
monitors the weight of the container 12 associated with the scale 14, using feedback from the scale 14;
interrogates the database to determine the: required flow rate associated with the monitored weight; and the required actuator or motor speed; and
controls the: regulator 22 to adjust the flow through the conduit 16 to the required flow rate (as extracted from the database); and actuator or motor speed to adjust the actuator or motor speed to the required actuator or motor speed (as extracted from the database).

By varying water flow rate through the conduit 16 and the speed at which the conduit 16 outlet 18 moves across/over the containers 12 during watering, the plant watering system 10 is able to:
increase the ratio of containers 12 to conduit 16 outlets 18; and
optimise the plant watering process (e.g. by slowing down/reducing the frequency of water flow as the plant growing medium becomes increasingly saturated).

This solution reduces the length and complexity of conduit 16 required and saves water by reducing drainage of excess water from the containers 12.

1. A plant watering system (10) including:
a plurality of containers (12) for containing plant growing medium and plants (20);
a conduit (16) defining an outlet (18) for, in use, conveying water along the conduit and discharging water via the conduit outlet;
a regulator (22) for regulating the flow of water along the conduit;
a scale (14) associated with one of the containers for determining the weight of the associated container;
a controller (24) that controls the regulator, thereby to vary the flow of water along the conduit in response to the container weight determined by the scale;
means for moving the conduit outlet across the plurality of containers, in use to provide water to the plurality of containers; and
a database that stores:
a first predetermined weight associated with zero flow along the conduit;
a second predetermined weight associated with 100% flow along the conduit; and
at least one intermediate weight associated with flow along the conduit that is between 0% and maximum flow along the conduit,
characterised in that the controller includes a processor that controls the regulator in response to: the weight determined by the scale; and the data in the database.

2. The plant watering system according to claim 1, wherein the conduit moving means comprises either:
a hinged mount on which the conduit is mounted; and an actuator or motor for angularly displacing the conduit about the hinged mount; or
a runner on which the conduit is mounted; a rail along which the runner is movable; and an actuator or motor for moving the runner along the rail.

3. The plant watering system according to claim 2, wherein the database further includes:
a zero actuator or motor speed associated with the first predetermined weight;
a first actuator or motor speed associated with the second predetermined weight; and
at second actuator or motor speed associated with at least one intermediate weight.

4. The plant watering system according to claim 3, wherein the speed of the actuator or motor is also controlled by the controller in response to: the weight determined by the scale; and the data in the database.

5. The plant watering system according to claim 4, wherein the scale is substantially dome-shaped, in use, to facilitate water runoff from the scale.

6. The plant watering system according to claim 5, wherein the regulator is a valve or a pump controller.
